(19) United States
(12) Patent Application Publication
(10) Pub. No.: US 2020/0114544 A1
(43) Pub. Date: Apr. 16, 2020

(54) Method and Apparatus for Manufacturing Fiber Composite Parts Utilizing Direct, Continuous Conversion of Raw Materials

(71) Applicant: Arris Composites Inc., Berkeley, CA (US)

(72) Inventors: Riley REESE, Carpinteria, CA (US); Ethan ESCOWITZ, Berkeley, CA (US); Erick DAVIDSON, Piedmont, CA (US)

(21) Appl. No.: 16/653,306

(22) Filed: Oct. 15, 2019

Related U.S. Application Data
(60) Provisional application No. 62/744,952, filed on Oct. 12, 2018.

(51) Int. Cl. B29B 11/10; B29B 11/16; B29B 15/12; B29B 13/02; B29C 43/34

(52) U.S. Cl. CPC B29B 11/10; B29B 11/16; B29C 70/521; B29B 13/02; B29C 43/34; B29B 15/12

(57) ABSTRACT

An apparatus and method for manufacturing fiber composite parts from a raw fiber tow to a finished composite part in a single continuous process are provided. The apparatus includes a continuous tow, a preheater/spreader to receive and spread the tow, an injection molding die downstream from the preheater/spreader to form an extrudate filament, a cooler downstream from the injection molding die, a forming die downstream from the cooler to pultrude and shape the cross-section of the extrudate filament, a preformer downstream from the forming die to heat and cut the extrudate filament to create preforms, a compression mold downstream from the preformer to form a finished fiber composite part, and a pick-and-place system to continuously pick each preform from the preformer and place each preform into the compression mold.

### CROSS-REFERENCE TO RELATED APPLICATION

This application claims priority to U.S. Provisional Patent Application No. 62/744,952, entitled Method and Apparatus for Direct, Continuous Conversion of Raw Materials to Finished Product, filed Oct. 12, 2018, the entire disclosure of which is incorporated by reference herein.

### FIELD OF THE INVENTION

The present invention relates to fiber composite parts. More specifically, the present invention relates to the manufacturing of fiber composite parts.

### BACKGROUND

A fiber composite includes fibers that are dispersed within a matrix. The matrix surrounds and supports the fibers by maintaining their relative positions, in addition to preventing the fibers from abrasion and environmental attack. The fibers impart their mechanical and physical properties to enhance those of the matrix. The combination is synergistic; the composite possesses material properties unavailable from the individual constituents, such as an exceptionally high strength-to-weight ratio.

There is a demand for high-volume, low-cost components (“parts”) that are made of fiber-composite materials, due to the superior material attributes (e.g., high strength, high stiffness, low mass, etc.) thereof. However, it can be challenging to produce them efficiently in such volumes.

### SUMMARY

The present invention provides a method and apparatus to speed the production of high-volume, fiber composite parts having fibers aligned, as desired, to an extent not possible in the prior art.

The present invention provides a method and apparatus to avoid drawbacks and costs of the prior art approaches to fabricating composite parts. Embodiments of the invention provide methods and apparatus producing finished product directly from raw fibers and resin.

Processing commodity raw fibers (e.g., carbon, glass, aramid, polymer, etc.) and thermoplastic polymer pellets directly to finished composite parts drastically reduces the finished product cost, increases the production speed, and ensures consistent quality for part production. Furthermore, embodiments of the invention enable the fabrication of much larger extrudate filaments and thicker tapes than were hitherto possible. With current processes, the tape or filament must be rolled or spooled or cut into short segments for transportation to the composite manufacturer. Since, in accordance with the invention, the filament and tape will be produced as the part is being fabricated, limitations pertaining to the ability to wind or transport the filament/tape are removed.

In a first exemplary embodiment of the present invention, an apparatus for manufacturing fiber composite parts from a raw fiber tow to a finished composite part in a single continuous process is provided. The apparatus includes a continuous supply of the raw fiber tow, a preheater/spreader, an injection molding die downstream from the preheater/spreader, a cooler downstream from the injection molding die, a forming die downstream from the cooler driven by a tensioning system, a preformer downstream from the forming die, and a compression mold downstream from the preformer. The apparatus provides for a direct, continuous conversion of raw materials into the finished fiber composite parts.

The apparatus may include a pick-and-place system to continuously pick preforms from the preformer and place each preform into the compression mold. The cooler may be a fan. The continuous supply of the raw fiber tow may be a spool of tow.

In a second exemplary embodiment of the present invention, an apparatus for manufacturing fiber composite parts from a raw fiber tow to a finished composite part in a single continuous process is provided. The apparatus includes a continuous supply of the raw fiber tow, a preheater/spreader adapted to receive and spread the tow, and an injection molding die downstream from the preheater/spreader that is adapted to impregnate the tow with melted thermoplastic and provide an extrudate filament. A cooler downstream from the injection molding die is provided to cool the extrudate filament to a temperature below a melting temperature of the thermoplastic, but above a glass transition temperature of the thermoplastic. A forming die downstream from the cooler is provided to pultrude and shape the cross-section of the extrudate filament. The forming die is driven by a tensioning system. A preformer is located downstream from the forming die that heats and cuts the extrudate filament to a desired length to create a plurality of preforms. A compression mold is located downstream from the preformer to form a finished fiber composite part. Finally, a pick-and-place system is used to continuously pick each preform from the preformer and place each preform into the compression mold. The apparatus provides for a direct, continuous conversion of raw materials into the finished fiber composite parts. The cooler may be a fan. The continuous supply of the raw fiber tow may be a spool of tow.

In a third exemplary embodiment of the present invention, an apparatus for manufacturing fiber composite parts from a raw fiber tow to a finished composite part is provided. The apparatus includes a continuous supply of the raw fiber tow. A preheater/spreader is provided to receive and spread the tow, the preheater/spreader having in inlet to receive the tow from the supply of raw fiber tow, and an outlet for providing preheated and spread tow. An injection molding die is provided having an inlet to receive the preheated and spread tow from the preheater/spreader, and having an inlet to receive thermoplastic pellets. The injection molding die impregnates the preheated and spread tow with melted thermoplastic to form an extrudate filament comprising fibers and thermoplastic. The extrudate filament exits the injection molding die via an injection molding die outlet. A cooler for cooling the extrudate filament is provided. The cooler has an inlet and an outlet, the inlet to receive the extrudate filament from the injection molding die and the cooler cooling the extrudate filament to a temperature below the meting temperature of the thermoplastic, but above the glass transition temperature of the thermoplastic. A forming die having an inlet and an outlet is provided. The inlet receives the cooled extrudate filament from the cooler and the forming die pultrudes and shapes the cross-section of the cooled extrudate filament. The forming die is driven by a tensioning system disposed downstream from the forming die. A preformer having an inlet and an outlet is provided. The inlet receives the shaped extrudate filament. The preformer heats and cuts the extrudate filament to a desired length to create a plurality of preforms. A compression mold downstream from the preformer is provided to form a finished fiber composite part. Finally, a pick- and place system is provided to continuously pick each preform from the preformer outlet and place each preform into the compression mold. The apparatus provides for a direct, continuous conversion of raw materials into the finished fiber composite part. The cooler may be a fan. The continuous supply of the raw fiber tow may be a spool of tow.

In a fourth exemplary embodiment of the present invention, a method for manufacturing fiber composite parts from raw material to finished composite part is provided. The raw material is a raw fiber tow. The tow includes a plurality of fibers. The method includes the continuous steps of preheating and spreading the tow; impregnating the tow under pressure with melted thermoplastic to form an extrudate filament comprising fibers and thermoplastic; cooling the extrudate filament to a temperature below a melting temperature of the thermoplastic but above a glass transition temperature of the thermoplastic; pultruding the extrudate filament through a forming die to shape the cross-section of the extrudate filament; heating and cutting the shaped extrudate filament to a desired length to create a plurality of preforms; molding each preform into a finished composite part; and ejecting each finished composite part from the mold. Manufacturing occurs in a direct, continuous conversion of raw materials into the finished composite part.

Preheating and spreading may be performed using heated rollers. The fibers in the tow may be, for example, carbon, glass, natural fibers, aramid, boron, metal, ceramic, polymer filaments, metal-particle and ceramic-particle laden fibers. Pultruding the extrudate filament through a forming die to shape the cross-section of the extrudate filament may form a rectangular, circular, triangular, oval, and tubular or polygonal cross-section. Heating and cutting may include a step of bending, to bend the extrudate filament to a desired bend radius. The step of molding may be a manual step.

Finally, in a fifth exemplary embodiment of the present invention, a method for manufacturing fiber composite parts from raw material to finished composite part is provided. The raw material is a raw fiber tow having a plurality of fibers. The method includes the continuous steps of preheating and spreading the tow; injection molding the preheated and spread tow, wherein thermoplastic is flowed over the tow under pressure to impregnate the preheated and spread tow with melted thermoplastic to form an extrudate filament comprising fibers and thermoplastic; cooling the extrudate filament to a temperature below a melting temperature of the thermoplastic, but above a glass transition temperature of the thermoplastic; pultruding the extrudate filament through a forming die to shape the cross-section of the extrudate filament, the forming die driven by a tensioning system; preforming the shaped extrudate filament to heat and cut the extrudate filament to a desired length to create a plurality of preforms; continuously compression molding each preform to mold each preform into a finished composite part; and ejecting each finished composite part from the mold. Manufacturing occurs in a direct, continuous conversion of raw materials into the finished composite part.

Preheating and spreading may be performed using heated rollers. The fibers in the tow may be, for example, carbon, glass, natural fibers, aramid, boron, metal, ceramic, polymer filaments, metal-particle and ceramic-particle laden fibers. Pultruding the extrudate filament through a forming die to shape the cross-section of the extrudate filament may form a rectangular, circular, triangular, oval, and tubular or and polygonal cross-section. Heating and cutting may include a step of bending, to bend the extrudate filament to a desired bend radius. The step of molding may be a manual step.

Additional embodiments of the invention comprise any other non-conflicting combination of features recited in the above-disclosed embodiments and in the Detailed Description below.

### BRIEF DESCRIPTION OF THE DRAWINGS

The invention will be described in conjunction with the following drawings in which like reference numerals designate like elements and wherein:

FIG. 1 depicts a simplified schematic diagram of an apparatus for manufacturing fiber composite parts utilizing direct, continuous conversion of raw materials in accordance with an illustrative embodiment of the present invention; and

FIG. 2 depicts a flow chart of a method for manufacturing fiber composite parts utilizing direct, continuous conversion of raw materials in accordance with an illustrative embodiment of the present invention.

### DETAILED DESCRIPTION

The following terms, and their inflected forms, are defined for use in this disclosure and the appended claims as follows:
“Composite Part” means a part made from composite material made from two or more constituent materials with significantly different physical or chemical properties that, when combined, produce a material with characteristics different from the individual components. The individual components remain separate and distinct within the finished structure.
“Fiber” means an individual strand of material. A fiber has a length that is much greater than its diameter. In the context of composites, fibers are classified as (i) chopped/discontinuous or (ii) continuous. Chopped fibers have a length that is much shorter than the part in which they are used; continuous fibers have a length that is comparable to the size of the part in which they are used. Chopped fibers typically have a random orientation in the matrix or final part; continuous fibers usually have a defined and unidirectional orientation in the matrix or part. As used herein, the term “fiber” means continuous fiber, unless modified by the term “chopped” or “cut”.
“Extrudate Filament” means raw fiber plus binder and metal, or binder and ceramic, or binder and metal and ceramic, and optionally, flow additives and fillers. The term, although “singular,” refers to many (typically thousands) of such material-laden fibers, since embodiments of the invention do not and cannot address a single fiber. Extrudate filament has a defined cross-section, typically circular, oval, or rectangular, as defined by passing the material-laden fiber through a die. It is notable that this is not the conventional usage of the term “filament,” which is generally considered to be synonymous with “continuous fiber.”
“Preform” means altered (e.g., bent, sized, etc.) extrudate filament.
“Tow” means an untwisted and unidirectional bundle of continuous fiber. The term “bundle” is used herein synonymously with the terms roving and tow. Tows usually contain multiples of 1000 fibers, such as a 1K tow (1000 fibers), a 12K tow (12,000 fibers), a 24K tow (24,000 fibers), etc.

Other than in the examples, or where otherwise indicated, all numbers expressing, for example, quantities of ingredients used in the specification and in the claims are to be understood as being modified in all instances by the term “about.” Accordingly, unless indicated to the contrary, the numerical parameters set forth in the following specification and attached claims are understood to be approximations that may vary depending upon the desired properties to be obtained in ways that will be understood by those skilled in the art. Generally, this means a variation of at least +/−20%.

Also, it should be understood that any numerical range recited herein is intended to include all sub-ranges encompassed therein. For example, a range of “1 to 10” is intended to include all sub-ranges between (and including) the recited minimum value of about 1 and the recited maximum value of about 10, that is, having a minimum value equal to or greater than about 1 and a maximum value of equal to or less than about 10.

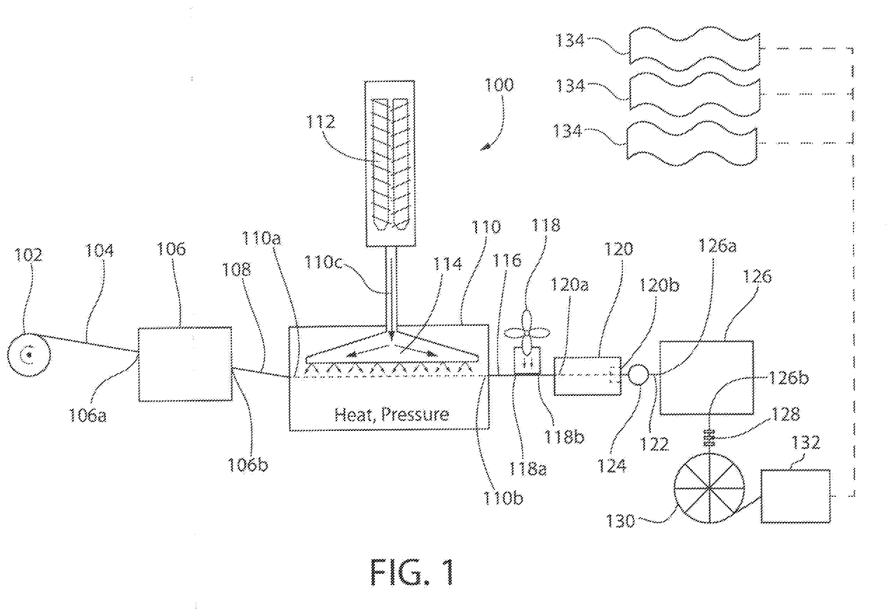

Referring now to the drawing figures wherein like reference numbers refer to like elements throughout the several views, there is shown in FIG. 1 a simplified schematic diagram of an apparatus for manufacturing fiber composite parts utilizing direct, continuous conversion of raw materials 100 in accordance with illustrative embodiment of the present invention. The apparatus 100 includes a spool 102 of a raw fiber tow 104, the tow 104 including a substantially continuous, untwisted filaments. A preheater/spreader 106 receives and spreads the tow 104. The preheater/spreader 106 has in inlet 106a and an outlet 106b. The inlet 106a receives the tow 104 from the spool 102. The outlet 106b outputs the preheated and spread tow 108 to an injection molding die 110. The injection molding die 110 has an inlet 110a to receive the preheated and spread tow 108 from the preheater/spreader 106. The injection molding die 110 also has an inlet 110c to feed thermoplastic pellets 112 to the injection molding die 110. The injection molding die 110 impregnates the preheated and spread tow 108 with melted thermoplastic 114 to form an extrudate filament 116 comprising fibers and thermoplastic. The injection molding die 110 has an outlet 110b wherein the extrudate filament 116 exits the injection molding die 110 via the outlet 110b.

The extrudate filament 116 that leaves the outlet 110b of the injection molding die 110 then enters a cooler 118 (for example, a fan) for cooling the extrudate filament 116. The cooler 118 has an entry point 118a and an exit point 118b. The cooler inlet 118a receives the extrudate filament 116 from the injection molding die outlet 110b and the cooler 118 cools it to a temperature below the melting temperature of the thermoplastic 114, but above the glass transition temperature of the thermoplastic 114.

Next, A forming die 120 pultrudes and shapes the cross-section of the cooled extrudate filament 116. The forming die 120 has an inlet 120a and an outlet 120b. The forming die inlet 120a receives the cooled extrudate filament 116 from the cooler exit point 118b to pultrude and shape the cross-section of the cooled extrudate filament 116 to form shaped extrudate filament 122. The forming die 118 is driven by a tensioning system 124 disposed downstream from the forming die 120.

A preformer 126 is located downstream from the forming die 120 tensioning system 124 and also has an inlet 126a and an outlet 126b. The performer inlet 126a receives the shaped extrudate filament 122 from the forming die outlet 120b and heats and cuts the extrudate filament to a desired length thereby creating preforms 128.

A pick- and place system 130 continuously picks each preform 128 from the preformer outlet 122b and places each preform into a compression mold 132 to form final composite parts 134.

The apparatus 10 provides for a direct, continuous conversion of raw materials (raw fiber tow 104) into the finished fiber composite parts 134.

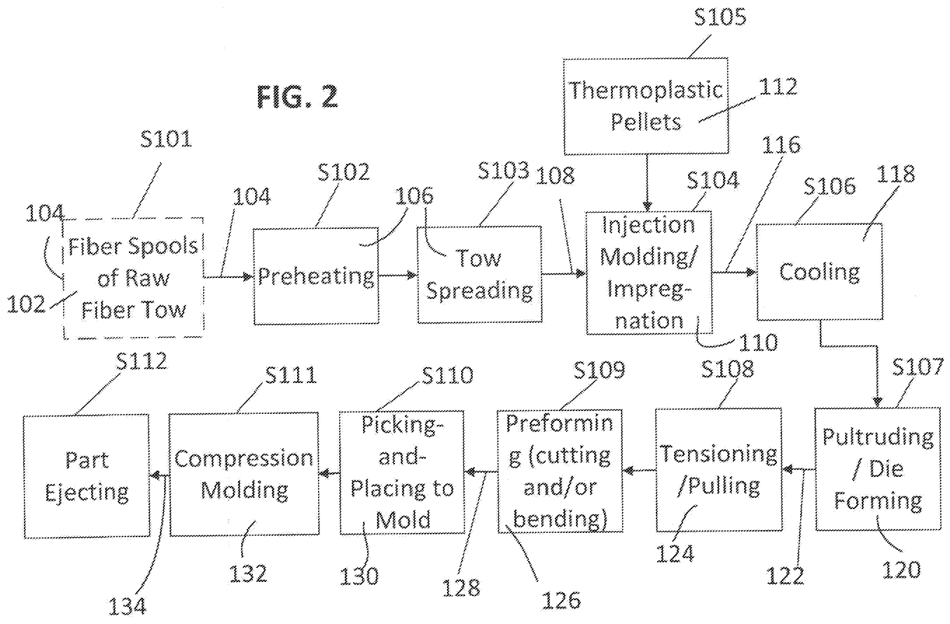

As can be seen in the flow chart of FIG. 2, a method for manufacturing composite parts utilizing direct, continuous conversion of raw materials in accordance with an illustrative embodiment of the present invention is also provided. The method may use, for example, the apparatus 100 described above. For the sake of convenience, numbers referencing various physical elements used with respect to the apparatus 100 are used in describing the method below, but FIG. 1 and accompanying text should be referenced for a description of such elements.

The method utilizes a spool of raw material 102 for processing (step S101). The raw material 102 is a raw fiber tow 104 comprising a substantially continuous, untwisted fibers. The tow 104 is preheated (step S102) and spread (step S103). The steps of preheating and spreading may be accomplished by using, for example, a preheater/spreader 106 such as heated rollers. The preheated and spread tow 108 is fed into an injection molding die 110 for impregnating the tow with thermoplastic 114 (step 104) wherein thermoplastic pellets 112 are fed into the die (step S105), melted and flowed over the tow under pressure to impregnate the preheated and spread tow 108 with melted thermoplastic 114 to form an extrudate filament 116 comprising fibers and thermoplastic.

The method continues with the step of cooling the extrudate filament 116 (using, for example, a cooler 118 such as a fan) to a temperature below a melting temperature of the thermoplastic 114, but above a glass transition temperature of the thermoplastic 114 (step S106). The resin remains malleable. The extrudate filament 116 is pultruded through a forming die 120 to shape the cross-section of the extrudate filament 122 (step S107). The cross-section of the shaped extrudate filament 122 may be, for example, rectangular, circular, triangular, oval, etc.). The forming die 120 is driven by a tensioning system 124 for pulling the extrudate filament through the die (step S108). Next, the shaped extrudate filament 122 is fed into a preformer 126 to heat and cut the shaped extrudate filament 122 to a desired length to create a plurality of preforms 128 (step S109). The performer 128 may use a bending die to bend the extrudate filament to a specific angle and/or bend radius.

The individual preforms 128 are continuously picked up and placed into a compression mold 132 to mold each preform into a finished part 134 (Step S110). In this step, a pick-and-place system 130 (e.g., manual operation, SCARA, 6-axis robot, X,Y gantry, etc.) picks up the preform after it is cut and places it in the desired position in the mold. One mold can contain one cavity/part or can contain multiple cavities/parts. This process is continuous so preforms are continually placed in a mold. Once the mold cavity is filled, the mold is moved to a compression molding step (step S112) and a new, empty mold takes its place. Finally, the finished part 134 is ejected (step S114). Movement of the preforms 128 into the compression mold 132 and of finished parts 134 out of the compression mold 132 can be done manually or using a rotary table or automated sliding gantry. These steps should occur quickly to allow for continuous pick-and-place of the preforms 128 and prevent delays or stoppages.

By use of the method described herein, manufacturing occurs in a direct, continuous conversion of raw materials into the finished composite part.

With respect to movement of the preforms 128 into the compression mold 132 and of ejecting finished parts 134 out of the compression mold (steps S110 and S112), these parts may be moved from the mold using a single pick-and-place system 130 or two separate systems. The pick-and-place systems 130 may switch out different end effectors for each operation or use the same end effectors.

It is considered to be within the scope of the present invention that the method or elements therefor may be duplicated in parallel, thereby combining multiple lines into one automated system.

Multiple processing lines (e.g., steps S101 through steps S110) can be used on one part where multiple preforms 128 are being placed simultaneously (or nearly at the same time) into one mold.

Multiple processing lines can be used for multiple parts with each line feeding into a specific part. In such embodiments, multiple preforms 128 are fed into multi-cavity molds to produce multiple parts at once.

Moreover, multiple processing lines can be used to produce different sized and/or shaped preforms 128 for one part. For example, it may be useful to have a large rectangular preform 128 to fill the center of the mold cavity and small circular preforms 128 to fill in smaller channels of the mold cavity.

The method and apparatus described herein is applicable to most fibers, including, without limitation, carbon, glass, natural fibers, aramid, boron, metal, ceramic, polymer filaments, metal-particle or ceramic-particle laden fibers, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing.

The method and apparatus described herein applies to all thermoplastic composites, but may or may not apply to other types of polymers. Resins suitable for use in conjunction with embodiments of the invention include, without limitation: acrylonitrile butadiene styrene (ABS), nylon, polyaryletherketones (PAEK), polybutylene terephthalate (PBT), polycarbonates (PC), and polycarbonate-ABS (PC-ABS), polyetheretherketone (PEEK), polyetherimide (PEI), polyether sulfones (PES), polyethylene (PE), polyethylene terephthalate (PET), polyphenylene sulfide (PPS), polyphenylsulfone (PPSU), polyphosphoric acid (PPA), polypropylene (PP), polysulfone (PSU), polyurethane (PU), polyvinyl chloride (PVC).

While the invention has been described in detail and with reference to specific embodiments thereof, it will be apparent to one skilled in the art that various changes and modifications can be made therein without departing from the spirit and scope thereof.

What is claimed:

1. An apparatus for manufacturing fiber composite parts from a raw fiber tow to a finished composite part in a single continuous process, the apparatus comprising:
(a) a continuous supply of the raw fiber tow;
(b) a preheater/spreader;
(c) an injection molding die downstream from the preheater/spreader;
(d) a cooler downstream from the injection molding die;
(e) a forming die downstream from the cooler driven by a tensioning system;
(f) a preformer downstream from the forming die; and
(g) a compression mold downstream from the preformer;
whereby the apparatus provides for a direct, continuous conversion of raw materials into the finished fiber composite parts.

2. The apparatus for manufacturing fiber composite parts of claim 1, including a pick-and-place system to continuously pick preforms from the preformer and place each preform into the compression mold.

3. The apparatus for manufacturing fiber composite parts of claim 1, wherein the cooler is a fan.

4. The apparatus for manufacturing fiber composite parts of claim 1, wherein the continuous supply of the raw fiber tow is a spool of tow.

5. An apparatus for manufacturing fiber composite parts from a raw fiber tow to a finished composite part in a single continuous process, the apparatus comprising:
(a) a continuous supply of the raw fiber tow;
(b) a preheater/spreader adapted to receive and spread the tow;
(c) an injection molding die downstream from the preheater/spreader, the injection molding die adapted to impregnate the tow with melted thermoplastic and provide an extrudate filament;
(d) a cooler downstream from the injection molding die, the cooler adapted to cool the extrudate filament to a temperature below a melting temperature of the thermoplastic, but above a glass transition temperature of the thermoplastic;
(e) a forming die downstream from the cooler, the forming die adapted to pultrude and shape the cross-section of the extrudate filament, the forming die driven by a tensioning system;
(f) a preformer downstream from the forming die, the preformer adapted to heat and cut the extrudate filament to a desired length to create a plurality of preforms;
(g) a compression mold downstream from the preformer, the compression mold adapted to form a finished fiber composite part; and
(h) a pick-and-place system to continuously pick each preform from the preformer place each preform into the compression mold;
whereby the apparatus provides for a direct, continuous conversion of raw materials into the finished fiber composite parts.

6. The apparatus for manufacturing fiber composite parts of claim 5, wherein the cooler is a fan.

7. The apparatus for manufacturing fiber composite parts of claim 5, wherein the continuous supply of the raw fiber tow is a spool of tow.

8. An apparatus for manufacturing fiber composite parts from a raw fiber tow to a finished composite part, the apparatus comprising:
(a) a continuous supply of the raw fiber tow;
(b) a preheater/spreader to receive and spread the tow, the preheater/spreader having in inlet to receive the tow from the supply of raw fiber tow, and an outlet for providing preheated and spread tow;
(c) an injection molding die having an inlet to receive the preheated and spread tow from the preheater/spreader, the injection molding die having an inlet to receive thermoplastic pellets, the injection molding die to impregnate the preheated and spread tow with melted thermoplastic to form an extrudate filament comprising fibers and thermoplastic, the extrudate filament exiting the injection molding die via an injection molding die outlet;
(d) a cooler for cooling the extrudate filament, the cooler having an inlet and an outlet, the inlet to receive the extrudate filament from the injection molding die, the cooler to cool the extrudate filament to a temperature below the melting temperature of the thermoplastic, but above the glass transition temperature of the thermoplastic;
(e) a forming die having an inlet and an outlet, the inlet to receive the cooled extrudate filament from the cooler, the forming die to pultrude and shape the cross-section of the cooled extrudate filament, the forming die driven by a tensioning system disposed downstream from the forming die;
(f) a preformer having an inlet and an outlet, the inlet to receive the shaped extrudate filament, the preformer to heat and cut the extrudate filament to a desired length to create a plurality of preforms;
(g) a compression mold downstream from the preformer, the compression mold to form a finished fiber composite part; and
(h) a pick- and place system to continuously pick each preform from the preformer outlet and place each preform into the compression mold.
whereby the apparatus provides for a direct, continuous conversion of raw materials into the finished fiber composite part.

9. The apparatus for manufacturing fiber composite parts of claim 8, wherein the cooler is a fan.

10. The apparatus for manufacturing fiber composite parts of claim 8, wherein the continuous supply of the raw fiber tow is a spool of tow.

11. A method for manufacturing fiber composite parts from raw material to finished composite part, the raw material being a raw fiber tow, the tow comprising a plurality of fibers, the method comprising the continuous steps of:
(a) preheating and spreading the tow;
(b) impregnating the tow under pressure with melted thermoplastic to form an extrudate filament comprising fibers and thermoplastic;
(c) cooling the extrudate filament to a temperature below a melting temperature of the thermoplastic, but above a glass transition temperature of the thermoplastic;
(d) pultruding the extrudate filament through a forming die to shape the cross-section of the extrudate filament;
(e) heating and cutting the shaped extrudate filament to a desired length to create a plurality of preforms;
(f) molding each preform into a finished composite part; and
(g) ejecting each finished composite part from the mold;
whereby manufacturing occurs in a direct, continuous conversion of raw materials into the finished composite part.

12. The method for manufacturing of claim 11, wherein the preheating and spreading is performed using heated rollers.

13. The method for manufacturing of claim 11, wherein the fibers in the tow are fibers selected from the group consisting of carbon, glass, natural fibers, aramid, boron, metal, ceramic, polymer filaments, metal-particle and ceramic-particle laden fibers.

14. The method for manufacturing fiber composite parts of claim 11, wherein pultruding the extrudate filament through a forming die to shape the cross-section of the extrudate filament forms a cross-section selected from the group consisting of rectangular, circular, triangular, oval, and tubular and polygonal.

15. The method for manufacturing fiber composite parts of claim 11, wherein the step of heating and cutting includes a step of bending, to bend the extrudate filament to a desired bend radius.

16. The method for manufacturing fiber composite parts of claim 11, wherein the step of molding is a manual step.

17. A method for manufacturing fiber composite parts from raw material to finished composite part, the raw material being a raw fiber tow, the tow comprising a plurality of fibers, the method comprising the continuous steps of:
(a) preheating and spreading the tow;
(b) injection molding the preheated and spread tow, wherein thermoplastic is flowed over the tow under pressure to impregnate the preheated and spread tow with melted thermoplastic to form an extrudate filament comprising fibers and thermoplastic;
(c) cooling the extrudate filament to a temperature below a melting temperature of the thermoplastic, but above a glass transition temperature of the thermoplastic;
(d) pultruding the extrudate filament through a forming die to shape the cross-section of the extrudate filament, the forming die driven by a tensioning system;
(e) preforming the shaped extrudate filament to heat and cut the extrudate filament to a desired length to create a plurality of preforms;
(f) continuously compression molding each preform to mold each preform into a finished composite part; and
(g) ejecting each finished composite part from the mold;
whereby manufacturing occurs in a direct, continuous conversion of raw materials into the finished composite part.

18. The method for manufacturing of claim 17, wherein the preheating and spreading is performed using heated rollers.

19. The method for manufacturing of claim 17, wherein the fibers in the tow are fibers selected from the group consisting of carbon, glass, natural fibers, aramid, boron, metal, ceramic, polymer filaments, metal-particle and ceramic-particle laden fibers

20. The method for manufacturing fiber composite parts of claim 17, wherein pultruding the extrudate filament provides a cross-section selected from the group consisting of rectangular, circular, triangular, oval, and tubular and polygonal.

21. The method for manufacturing fiber composite parts of claim 17, wherein preforming the extrudate filament includes bending the extrudate filament to a desired bend radius.

22. The method for manufacturing fiber composite parts of claim 17, wherein compression molding is manual step.
